(19) United States
(12) Patent Application Publication
(10) Pub. No.: US 2002/0065922 A1
(43) Pub. Date: May 30, 2002

(54) Method and apparatus for selection and redirection of an existing client-server connection to an alternate data server hosted on a data packet network (DPN) based on performance comparisons

(76) Inventor: Vijnan Shastri, Ercinitas, CA (US)

Correspondence Address: CENTRAL COAST PATENT AGENCY, PO BOX 187, AROMAS, CA, 95004, US

(21) Appl. No.: 09/727,906

(22) Filed: Nov. 30, 2000

(51) Int. Cl. G06F 15/16

(52) U.S. Cl. 709/227; 709/203; 709/231

(57) ABSTRACT

A system is provided for effecting a dynamic switch from an existing client-server connection established between a client node and a server node on a data-packet-network (DPN) to an alternate server-node connected to the network and accessible to the client node. In a preferred embodiment, the system utilizes a unique software module residing on and executing from a client-node, which functions to monitor current quality of service (QoS) data relative to existing client-server connections. The module opens temporary client-server connections to alternate servers while a user is connected to an existing server for the purpose of sampling QoS characteristics of the alternate servers and associated network paths and generating estimations of total value of services. The module compares actual QoS values with estimated values and selects an alternate server based on results of the comparison. A dynamic switch of server connection may be automatically achieved, which is largely transparent to a user operating the client node.

### FIELD OF THE INVENTION

The present invention is in the field of multimedia content-distribution over a data packet network (DPN) and pertains more particularly to methods and apparatus for enabling customer-premise-equipment (CPE) to select and redirect an existing client-server connection to an alternate source server based on performance comparison results calculated during an active transfer session.

### BACKGROUND OF THE INVENTION

Media distribution over a data-packet-network (DPN) network, such as the well-known Internet network, is accomplished between at least two distributed nodes connected to the network. For example, one node designated as a sending node typically sends content to a second node designated as a receiving node. Any node may be a sending or a receiving node depending on the nature and intent of the transaction. A DPN carries data that is organized into packets, which are addressed from a sending or source node to a receiving or end node. A DPN comprises all of the lines, connection points and equipment that make up a communications or data transfer network. A good example of a DPN is the well-known Internet network, which is described as a preferred example throughout this specification.

Data traffic on the Internet may assume any of a number of varying media types. Some examples are e-mail, IP telephony, electronic information page, fax, voice message, file share, and so on. Better techniques for data management and transmission over networks, along with the advent of more powerful processors and architectures providing additional computing power for connected nodes has recently made transferring video/audio files a practical reality for DPN implementation. The transfer of video/audio content over a DPN is often termed in the art multimedia steaming.

Streaming technology involves near real-time data transfer of multimedia files over a data link or channel set up between one node and another. Streamed media may be displayed as it downloads and in preferred situations, quality of the media is as good as if downloaded in it's entirety and then played on a display system. Software implemented at both a sending and receiving station functions to compress data for sending and to uncompress media at receipt and display of multimedia content. Software media players are provided to enable display of multimedia content whether the content is audio, video, or a combination thereof.

One with skill in the art of media transfer, especially that over the Internet, will appreciate that there are now many companies providing multimedia content to end users. End users typically subscribe to offered services and connect to the Internet for the purpose of receiving streamed content for display on their respective network-connected nodes.

The technology described above wherein video/audio content is streamed to end-users encompasses a wide range of equipment, software, and delivery mediums. For example, users (customers) may download streaming content to personal computers connected to the network over standard telephone lines. Special digital services such as Integrated Services.

Some companies involved in providing multimedia content to end users offer a smart mirror system that automatically selects a best performing server based on statistics before a user begins receiving content. After a server is selected and connection to the server is established, the content automatically begins streaming to a user's site and equipment.

One problem with the method described above is that performance capabilities exhibited by a multimedia server are not often consistent over long periods, such as a period of time covering an entire streamed movie, for example. A best-performing server selected by the smart mirror process may begin to degrade shortly after selection and initiation. If quality begins dropping to a level that is unsatisfactory to a user, he or she must break the connection and begin the process all over again with a newly selected server. If this happens more than once during an attempt to download and view a selected offering, a user may become annoyed and abandon the process altogether.

What is clearly needed is a method and apparatus wherein a user may dynamically switch to a better-performing server during playback of a streamed multimedia selection without losing his or her place in the selection. Such a method and apparatus would provide increased user confidence and satisfaction with multimedia streaming processes as a whole and allow companies to retain more satisfied subscribers for on-demand services.

### SUMMARY OF THE INVENTION

In a preferred embodiment of the present invention a system for replacing data services of a server-node connected to a client-node with data services available from an alternate server-node operating on a data-packet-network is provided, comprising a first server-node; a client node coupled by data link to the first server-node; an alternate second server-node connected to the network and accessible to the client node; and a software module. The system is characterized in that the software module monitors one or more quality-of-service values from the first and second server nodes, and switches communication for the client node between server nodes accordingly.

In some embodiments the switching is based on comparison of performance data collected and processed by the software module. Also in some preferred embodiments the data services comprise streaming multimedia media content. preferably the software module resides at the client location, and operates transparently to the client node.

In another aspect of the invention a software module for enabling selective replacement of data services of a server-node connected to a client-node with data services available from an alternate server-node operating on a data-packet-network is provided, comprising a data input function for receiving data from external sources; an analytical function for compiling received data and producing a result based on data comparison; and a command function for effecting a client-server connection switch.

In this embodiment of the software module, the termination of a current client-server connection and the establishment of a replacement client-server connection is based on comparison of performance data collected and processed by the module. The module preferably resides at the client location, and operates transparently to a user. Also the processed performance data is compared against a pre-set threshold value. The performance data may be equated to a point system and values are assigned to compiled sets of data. In some embodiments an option to switch client-server connection from one server node to an alternate server node is presented to a user operating at the client location.

In yet another aspect of the invention a method for replacing data services of a server-node connected to a client-node with data services available from an alternate server-node operating on a data-packet-network is provided, comprising (a) monitoring performance characteristics of the server-node connected to the client node, and the performance characteristics of the network path between the server-node and the client-node; (b) establishing a temporary client-server connection between the client-node and an alternate server-node; (c) recording performance characteristics of the alternate server-node, and the performance characteristics of the network path between the alternate server-node and the client-node; (d) comparing the total value of performance characteristics of the server-node with the estimated value of available performance characteristics of the alternate server-node; and (e) initiating a client-to-server connection switch based on the results of the comparison.

In this method, in step (a), monitored results may be continuously compared against a pre-set threshold value for determination of whether to proceed to step (b). In another embodiment initiation of the client-to server connection switch is user directed from the client location.

In embodiments of the present invention disclosed in enabling detail below, for the first time a system is provided, operable on a client station, that will dynamically and automatically switch from one server to another streaming the same data, if the alternate server is a better choice at any time in the transmission

### BRIEF DESCRIPTION OF THE DRAWING FIGURES

FIG. 1 is a network overview of a multimedia distribution system according to an embodiment of the present invention.

FIG. 2 is a block diagram illustrating various components of a multimedia software player enhanced for dynamic-server-selection (DSS) according to an embodiment of the present invention.

FIG. 3 is a block diagram illustrating capability of a DSS module according to an embodiment of the present invention.

FIG. 4 is a process flow diagram illustrating automated steps for server selection according to an embodiment of the present invention.

FIG. 5 is a process flow diagram illustrating semi-automated steps for server selection according to another embodiment of the present invention.

### DESCRIPTION OF THE PREFERRED EMBODIMENTS

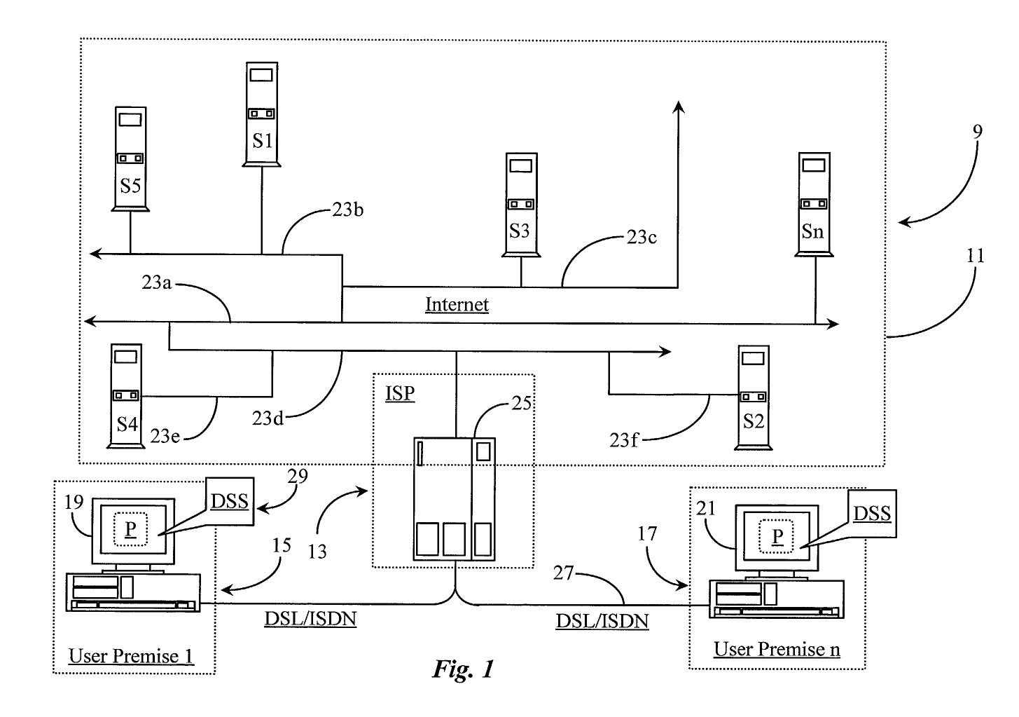

FIG. 1 is a network overview of a multimedia distribution system 9 according to an embodiment of the present invention. Multimedia distribution system 9 illustrates a system for distribution and receipt of multimedia content wherein dynamic server selection (DSS) is practiced according to an embodiment of the present invention.

System 9 utilizes a DPN 11, which in this example is the well-known Internet network and will hereinafter be referred to as Internet 11. Internet 11 represents a preferred DPN for practicing the present invention. Internet 11 is chosen as a preferred medium because of its high public-access characteristic. In alternative embodiments, other DPNs may be utilized such as a corporate Wide-Area-Network (WAN), an Intranet network, or any other DPN that supports multimedia data transfer protocols.

In this example, Internet 11 is illustrated as exhibiting separate network portions or frees. For example, an Internet backbone 23a represents a main Internet backbone to which geographically separated trees are connected. Connected directly to backbone 23a are trees 23b and 23d. Connected to tree 23d are trees 23e and 23f. Connected to tree 23b is tree 23c. The inventor illustrates separate trees branching from backbone 23a for the purpose of illustrating the tiered nature of the Internet including connected sub-nets, and to also illustrate separation (electronic distance) related to certain nodes and customer access gateways included in Internet 11.

A plurality of data-severs S1-Sn are illustrated as connected to different trees of Internet 11. Servers S1-Sn represent multimedia distribution servers adapted to serve multimedia content to requesting, authorized, computer nodes. Servers S1-Sn may be assumed to be hosted by one or more companies engaged in the provision of multimedia content to end-users/subscribers. Servers S1-Sn are distributed throughout Internet 11 and are dedicated as multimedia servers, which are known in the art, and are accessible by clients of the hosting company or companies, typically through subscription services.

Server Sn is illustrated as connected to Internet backbone 23a. Servers S5 and S1 are connected to tree 23b. Server S3 is connected to tree 23c. Server S4 is connected to tree 23e, and server S2 is connected to tree 23f Server distribution is somewhat random in this example, and serves to illustrate electronic distance variations from a particular customer gateway, which is represented herein by an Internet-Service-Provider (ISP) 13 and various server nodes. ISP 13 is enabled to provide normal Internet services as are known in the art of dial-up Internet access. In this case, connection services are performed by a connection server represented herein by element number 25. Server 25 may also serve as a customer-access point to services offered by companies hosting servers S1-Sn. ISP 13 is typically reached through a telephone network such as the Public-Switch-Telephone-Network (PSTN) as is known in the art. A strict PSTN is not illustrated in this example but may be assumed to be present. The skilled artisan will recognize that the example of an ISP is only one example of how Internet access may be achieved.

Two user premises, 15 and 17, are illustrated in this example as having Internet connection to ISP 13 for the purpose of accessing Internet 11. Premise 15 comprises a personal computer (PC) node 19, which in this case represents Internet-capable equipment required to access Internet 11 through ISP 13 as is known in the art. Premise 17 is equipped and functional identical to that of premise 15 as illustrated by PC 21, although this is not required for successful practice of the present invention. What is minimally required is an Internet-capable appliance, supporting software and an Internet connection. In this example, both premises 15 and 17 utilize the same ISP (13) in order to gain access to Internet 11, although many users may access through different ISPs and by different ways than through an ISP. Similarly, both premise 15 and premise 17 are enhanced with high-speed Internet access capability represented by respective access lines labeled DSL/ISDN.

Digital Service Line (DSL) is a service known in the art for providing high-speed Internet access on behalf of users. Integrated Services Digital Network (ISDN) is another service improving bandwidth capabilities for Internet users. In both cases, special digital carrier lines are installed as part of the user's equipment. The Internet-access configurations described above are well-known in the art and represent optimum equipment and connection capability for receiving multimedia content over Internet 11. However, the above-described configurations are exemplary only and should not be construed as a limitation of the practice of the present invention. Internet access may be achieved, in other embodiments, by other methods such as normal telephone line/modem access, cable/modem set-up, or via a wireless Internet connection, all of which are well known.

It will be apparent to one with skill in the art that system 9, as represented herein, illustrates a tiny portion of Internet 11 as there may be many more servers, ISPs and user premises connected thereto without departing from the spirit and scope of the present invention. In this broad sense, there is no geographic limit to the practice of the present invention. The inventor deems that illustration of a portion of network 9 is sufficient for the purpose of explaining the present invention.

In practice, system 9 provides end-users (user premises 1-n) with a choice among multiple distributed servers (S1-Sn) for receiving the same streaming multimedia content. Therefore, it can be assumed that each of servers S1-Sn contains multimedia content, which is mirrored in multiple ones of the servers and available by on-demand request. For example, a user operating from premise 15 may connect to ISP 13 and may access server 25. Server 25 may host a service page (not shown) listing available titles of multimedia content such as full-length movies. By selecting one of the offered titles, multiple servers S1-Sn become optional severs for serving the content selected. In another embodiment, a main directory server (not shown) may be provided in Internet 11 by a company hosting servers S1-Sn.

In the background section it was described that some prior art systems use a smart mirror technique for selecting from multiple servers on behalf of the user. In some cases, a user must physically select a server from a presented list of servers. In both cases, when a user begins receiving content, the other distributed servers hosting the same content are not considered and are not available unless a user physically breaks connection with an original server and re-connects with one of the alternate servers.

The inventor provides a way for allowing a user's station to dynamically select from servers S1-Sn which server will be utilized for receiving content. Such dynamic selection may occur a number of times during active playback of selected multimedia content. For example, PC 19 at user premise 15 has a player, represented as a dotted rectangle P installed thereon and adapted to play media content streamed thereto from any one of servers S1-Sn. PC 21 at user premise 17 is, of course, similarly adapted. Player P is, in this embodiment, a plug-in for a browser application as generally known in the art and automatically launches when a connection to one of servers S1-Sn has been established and media content begins streaming.

A unique software module termed a dynamic-server-selection (DSS) module 29 is provided and adapted to integrate with player software P for the purpose of enhancing the player for practicing DSS during active viewing of a selected multimedia presentation. DSS 29 (also illustrated at PC 21) uses various Quality of Service (QoS) statistics, which may be determined in part by playback statistics and in part by server-provided information, in order to determine if one of servers S1-Sn may provide better service than a current server being used. If there is a better-performing server available, under certain circumstances DSS 29 enables a dynamic switching to the better-performing server. A multimedia selection from a new server may begin streaming at the point left off at the original server without interruption. DSS 29 also may be provided as a separate module that works in cooperation with player P. In a preferred embodiment however, DSS 29 is provided as part of an enhanced QoS reporting module contained in player P.

The method and apparatus of the present invention may be practiced in conjunction with a smart mirror technology, at least for purposes of designating a logical first server to begin streaming multimedia content to premise 15 or 17. Thereafter, an alternate server may be chosen during active streaming if it is determined that the alternate server offers a significantly better overall quality of service. In another embodiment, one of servers S1-Sn may be arbitrarily chosen as a first content-providing server by a company providing the streaming service, or by a subscribing user.

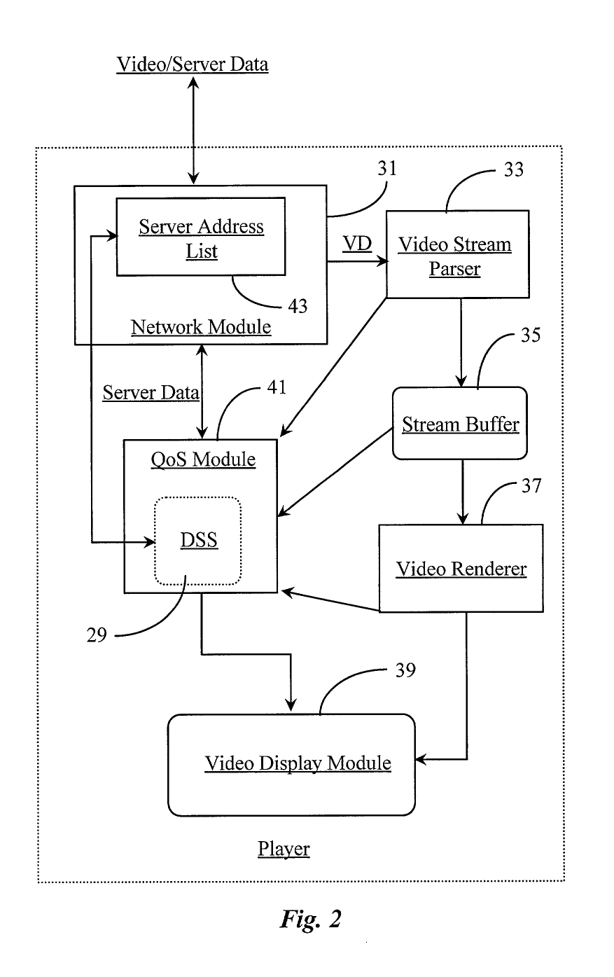

FIG. 2 is a block diagram illustrating various components of player P of FIG. 1, which is enhanced for dynamic-server-selection (DSS) according to an embodiment of the present invention. Player P, simply labeled Player in this diagram is made up of several components, which are important to its function.

A network module 31 is provided within player P and adapted as an interface for a WEB browser function of negotiation with any of servers S1-Sn of FIG. 1. A double arrow labeled Video/Server Data leading into module 31 represents a bi-directional communication capability wherein multimedia content and server (QoS) data is received at module 31. In addition to receiving video and QoS data from a current server, module 31 has a capability of connecting to and receiving data from another servers at the same time with the aid of browser software.

A Video stream parser 33 is provided and adapted to receive and parse video data. A directional arrow labeled VD indicates current video data transfer from module 31 to parser 33. A stream buffer 35 is provided and enabled to buffer video data passed to it by parser 33. A video renderer 37 is provided and enabled to render video data as bit-map images for display. A video display module 39 is provided and enabled to cause display of the images on a PC monitor for viewing purposes, as is generally known in the art.

Server data, described above, comprises QoS data passed from network module 31 and into a provided QoS module 41. Server data may be a combination of a variety of different states for a given server. For example, current bandwidth capability can be communicated. Server load may be determined and made part of a QoS report. Module 31 may be enhanced with a pinging capability (known in the art) for determining electronic distance from a particular server. Pinging for electronic distance may also be performed at server-side as well. Part of the server data sent to module 31 by an initial content-providing server contains a server address list 43. List 43 contains the IP addresses of all of the optional servers (S1-Sn) listed as having the same multimedia content available for downloading.

A QoS module 41 is provided and enabled to record current QoS data originating from a current server and from playback statistics. A directional arrow beginning at module 31 and leading into QoS module 41 represents server data and playback statistics being passed to module 41 during real time streaming and playback of the multimedia content. QoS receipt of playback statistics is illustrated by the diagonal directional arrows beginning at modules 33 (parser), 35 (buffer), and 37 (renderer) respectively and leading to QoS module 41. Each arrow represents a particular statistic provided by the associated module. In this way, current QoS performance attributes of a first or initial multimedia server may be accurately monitored.

Certain QoS statistics relating to current server performance are determined during playback by individual components contained in player P and passed to module 39 as part of normal function. This is illustrated by a directional path beginning at module 41 and leading to video display module 39. Once statistics arrive in module 39, they are displayed in real time during playback of the content. Generally speaking, overall QoS performance statistics give a real-time rate of data transfer in kilobits per second. Percentage figures are generally available pertaining to received and lost data packets, retained and lost video frames (streaming), and percentage of late arriving packets. A visible graph may illustrate percentage of target bandwidth available over a connection expressed in kilobits per second. Statistics indicating a measure of success regarding data reconstruction and recovery of lost data may also be available. Other useful data such as rate of decompression, stream buffering rates, and so on may also be included in assessment of overall quality.

QoS module 41 is functionally enhanced with DSS module 29. DSS module 29 is capable of utilizing current QoS performance statistics from a current server and connection providing multimedia content in comparison with estimated QoS performance capabilities compiled from sampling alternate servers using different connections. DSS 29 is also capable of receiving current playback statistics, which help to determine overall QoS for a given server, from other player components and considering those statistics when making a comparison. DSS module 29 is in effect a decision-making component that reads incoming statistical data generated by varying sources and formulates a decision based on the results of comparison.

In practice of the present invention, QoS data from a current server providing multimedia content is passed to QoS module 41 from network module 31 during streaming as previously described. Performance statistics from each of modules 33-37 are also reported to module 41. Module 41 makes the current server statistics visibly available to an interested viewer by passing them on to display module 39. By clicking on an option view statistics a user may bring them up on a monitor during viewing of a presentation. DSS 29, in cooperation with network module 31, is programmed to periodically contact and establish a connection with alternate media servers contained in list 43 for the purpose of accomplishing a small scale data transfer wherein a reasonable QoS estimate of each alternate server contacted may be obtained. This functional communication is illustrated herein by a bracketed double-arrow connecting DSS 29 with list 43 in network module 31.

DSS module 29 may be programmed to randomly or serially check with each server in list 43 for the purpose of formulating a QoS estimate for each alternate server to compare with current QoS performance of the server currently providing content. When an alternate server is found with a QoS estimate better than actual performance of a providing server, then DSS module 29 may effect a dynamic switch to that server. In one embodiment, several estimates are collected from alternate servers before a switch is made. In another embodiment, a QoS threshold is observed such that DSS module 29 only becomes active if a QoS of a current server begins to dip below the established threshold.

In some embodiments, DSS module 29 is also capable of changing the data-receiving characteristics of player P such that a lower Kps rate is observed in an event that quality is degrading and there are no better alternate servers variable.

It will be apparent to one with skill in the art that player P as a plug-in to a WEB browser utilizes standard browser components (not shown) for navigating to content for download. Network module 31 is an assumed interface to those standard navigation capabilities.

It will also be apparent to one with skill in the art that player P may contain more functional components than are illustrated in the example without departing from the spirit and scope of the present invention. Only those components required for function and which are affected by DSS enhancement are illustrated herein. Other player components not illustrated in this example are well-known in the art and may be assumed to be present.

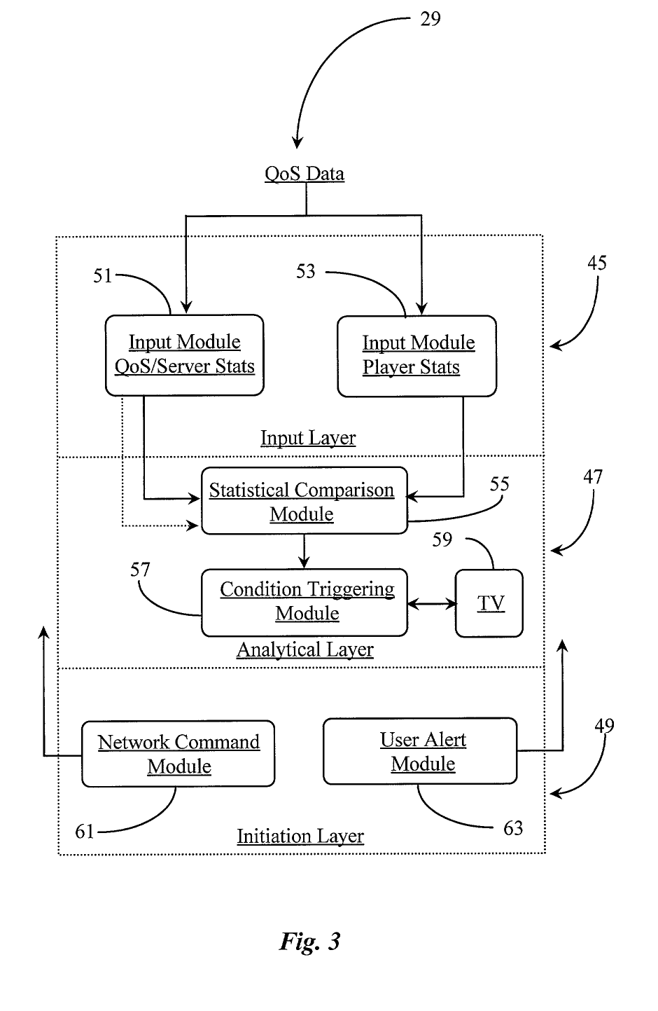

FIG. 3 is a block diagram illustrating various components of DSS module 29 of FIG. 1 according to an embodiment of the present invention. DSS module 29 comprises at least three basic software layers. These are an input layer 45, an analytical layer 47, and an initiation layer 49.

Input layer 45 is provided and adapted to receive data input from a content-providing server, components of a player, and data from an alternate server sampled for QoS data during playback. An input module 51 is provided within layer 45 and adapted to receive QoS data from a current server providing content and server test data from a second server being briefly sampled for QoS. For example, during playback of content provided by a first or initial server, constant QoS data arrives with media content. Periodically, separate connections are opened with alternate servers for the purpose of obtaining a sampling of QoS data by very briefly accepting the same media content from the second test server. Statistics include available bandwidth, current server load, electronic distance measurement, and actual bit rate of streaming content received from the server being sampled. The sample taken is not rendered for display, but simply monitored for bit rate during the brief period of sampling.

A second input module 53 is provided within layer 45 and adapted to receive playback statistics from player components. It is noted herein that certain playback statistics are not available for sampled servers because the media content sampled is not buffered or rendered. Moreover, sampling of an alternate server is performed for only a brief period. Therefore, only a reasonable estimate of QoS may be obtained from sampling an alternate server.

Layer 47 is adapted to receive data from layer 45 for the purpose of analyzing and comparing separate data sets. A Statistical comparison module 55 is provided within layer 47 and adapted to compare actual QoS readings from a current server being used to provide media to estimated QoS readings taken from one or a plurality of alternate servers during sampling. A solid directional arrow beginning at module 51 in layer 45 and leading to module 55 in layer 47 represents QoS data arriving from a current content providing server. A broken directional arrow adjacent to the arrow just described represents QoS data arriving from an alternate server during sampling. A solid directional arrow beginning at module 53 in layer 45 and leading to module 55 in layer 47 represents actual playback statistics associated with the current content-providing server.

It is noted herein that a point system may be used for QoS determination within module 55. A point system may equate to enterprise rules thereby incorporating different values on the point system for different QoS statistics. For example, separate statistics such as current rate of data transfer, current server load, total available bandwidth, and electronic distance measurements taken from a content-providing server may be assigned a point value, say from 1-10 based on enterprise rules.

When all of the point values for separate data readings are combined and averaged, an overall QoS rating value may be determined by module 55 for that server. The overall value of QoS of a content providing server is determined continuously in real time during streaming such that an average overall value over time may also be determined. QoS estimates determined from sampling alternate servers are compared to the above-described value.

In one embodiment, a plurality of sample QoS estimates may be determined and compiled for a plurality of optional servers before a QoS comparison is performed in module 55. In some cases, compared results will include the QoS value from the content-providing server and estimated QoS values from more than one optional server if they are the same. In this case, a weighted judgment may be made according to a higher level of enterprise rules for breaking a tie.

Module 55 passes comparison results to a condition-triggering module provided within layer 47 and represented herein with element number 57. Comparison results can be expressed very simply as two side-by-side values, one representing overall QoS of a content providing server, and one representing the estimated QoS value of a best competing alternate server. In one embodiment, module 57 receives the results and compares them against a threshold value (TV) illustrated as a box 59 connected to module 57 by a double arrow. If an actual QoS value registers below TV 59, and an estimated QoS value registers above TV 59, then a dynamic connection switch may be initiated from within layer 49.

In one embodiment, a dynamic switch may be triggered by other rules instead of applying a threshold value. For example, module 55 may attach a condition to a reported actual QoS value. Such a condition may indicate that the value has been steadily dropping during the elapsed time of playback due to increasing server load. An estimated value may register slightly lower than or the same as the actual value, but during the brief sampling, a lower server load was reported and a closer electronic distance was reported. A dynamic switch to the alternate server may be initiated in this case based on a predicted further degradation of the actual value and the favorable network conditions reported with the estimated value.

One with skill in the art will appreciate that comparison of an actual QoS value with one or more estimated values taken during sampling of other servers may be driven by a wide variety of rules and constraints without departing from the spirit and scope of the present invention. In still another embodiment, there may be no threshold or rules applied to a QoS determination and comparison routine. Further, it may be that actual QoS values are compared against estimated values on a case-by-case basis during sampling such that anytime an estimated value registers above an actual value, an automatic switch is made to the sampled server.

Assuming that a dynamic switch is triggered at module 57 based on results passed to it from module 55, a network command is issued by a network command module 61 provided within layer 49. The command to switch servers is sent to network module 31 of FIG. 2. Network module 31 receives the command and redirects connection to the new server, breaking the connection to the previous server. A slight pause in playback of video content may be noticed by a user during reconnection and subsequent streaming of content from the new server. However, this is an acceptable tradeoff when faced with an alternative of manually breaking a current connection because of degrading QoS and then physically re-connecting to an alternate server and starting the streaming process over again with uncertain prospects of receiving acceptable QoS.

A user alert module 63 is provided within layer 49 and adapted to provide a user with an option to switch servers if a better server is found. Module 63 is optional and only exists in an embodiment wherein permission to switch to an alternate server is solicited from a user. For example, at a point in time that an alternate server becomes a logical choice over a current server for streaming multimedia content, a screen pop or other type of alert may be used to inform a user of a dynamic switch option. In some cases a user may reject a switch option. One example might be if a switch option presents itself near the end of a presentation. Another might be if a switch option provides only a slight improvement in QoS which may be negligible to a user.

The method and apparatus of the present invention provides several benefits to users. One is that it may be assured that a best-suited server is being used throughout playback of content at all times. Another is that recovery from any sudden deterioration to a current network path may be effected by dynamically switching to an alternate server with an undisturbed network path. In an event of unexpected server failure, a dynamic switch to an alternate server may be initiated by default. Because a user is actively viewing a presentation during a DSS routine, the name of the file a user is viewing is known to player software. Therefore, redirection of a connection to an alternate server includes file selection and invocation to the point where the user last viewed.

It will be apparent to one with skill in the art that DSS 29 may be provided with more or fewer functional components than are illustrated in this example without departing from the spirit and scope of the present invention. For example, an interface to an external data repository may be included for the purpose of enabling DSS 29 to access the external data repository for the purpose of retrieving or storing information. Such a repository may be an internal repository such as a computer cache memory. Modules 55 and 57 may be combined to form one module capable of the functions of both. A software means adapted for updating server availability in the network may be added whereby a periodic check of the system might reveal the existence of any new optional servers brought on-line or the elimination of any existing servers taken off-line during the duration of playback of multimedia content. There are many possibilities.

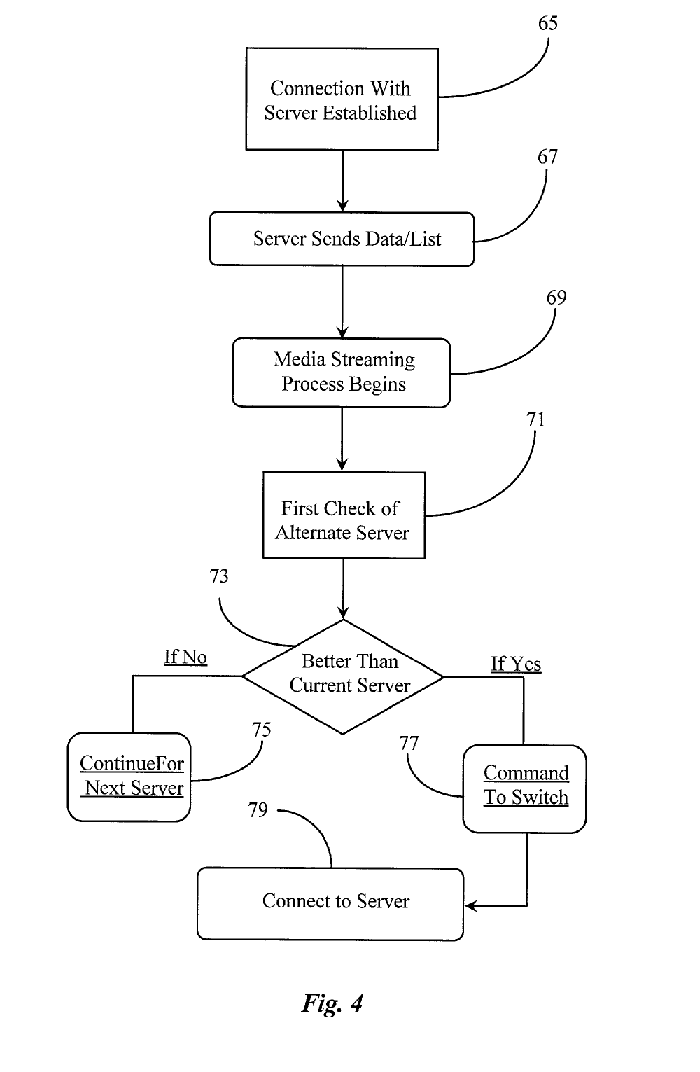

FIG. 4 is a process flow diagram illustrating automated steps for server selection according to an embodiment of the present invention. At step 65, a user establishes an on-line session with an initial multimedia server for the purpose of downloading and playing streaming content. Step 65 may be anticipated by first choosing a media selection from a directory server. In one embodiment, a smart-mirror sequence is performed by a directory server wherein the initial server is pre-selected before connection is established and streaming commences. At step 67, a complete address list of optional servers offering the same content for download is sent to a user's player software. The address list includes all of the data required to effect an on-line connection with each listed server.

At step 69, a multimedia presentation begins streaming to a user. Content may be of the form of a full-length movie or any other type of multimedia content that may be processed by player software. Statistics are gathered for compilation and determination of a current QoS value for the original server. At step 71, a first check of an alternate server listed on the list of step 67 is initiated. Step 71 includes establishing a connection with the alternate server and the initiation of streaming of the same file being provided by the original server of step 65. Step 71 occurs only for a brief period as required to establish a sample of the current bit rate of data transfer, a reading of electronic distance over the network path involved, and an indication of current server load.

At step 73, an estimated QoS value is determined for the alternate server of step 71 and compared against the actual QoS value for the original server of step 65. If it is determined that the estimated QoS of the alternate server is sufficiently better than the current QoS of the original server, then at step 77 a dynamic switch command is issued for the purpose of redirecting the user to the alternate server for continued service. At step 79, a connection is established with the chosen alternate server and the process resumes at step 69. If it is determined at5 step 73 that the estimated QoS is not sufficient to effect a switch, then the process resumes sampling alternate servers at step 75.

The inventor intends that this example of process flow illustrates just one example of how the present invention is practiced in an automated embodiment. There are other process flow variations that may be used in a fully automated embodiment without departing from the spirit and scope of the present invention. For example, a step for comparing a current QoS value against a threshold may be inserted between steps 69 and 71. Step 71 may include taking samples from a plurality of alternate servers before comparison in step 73. There are many possible process variations.

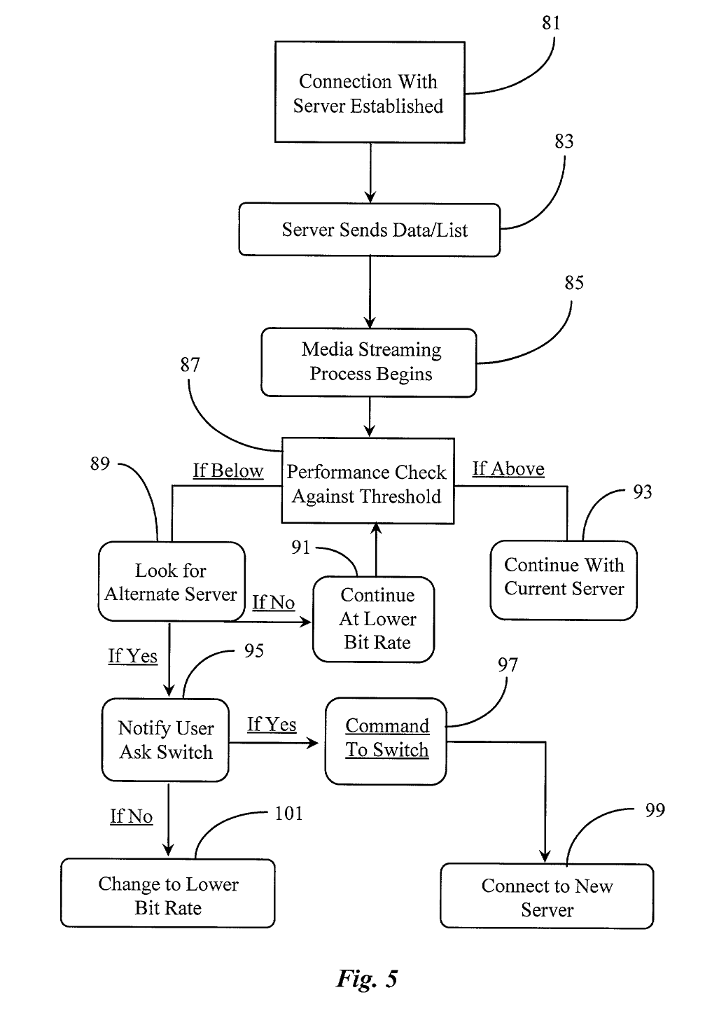

FIG. 5 is a process-flow diagram illustrating semi-automated steps for server selection according to another embodiment of the present invention. Steps 81, 83, and 85 are analogous to steps 65, 67, and 69 of FIG. 4. At step 85, QoS value is determined for the original server as mentioned in FIG. 4 regarding step 69. At step 87, the current QoS value for the original server it is determined and compared against a threshold value. The process of step 87 is continuous as media is streamed. In this example, if it is determined in step 93 that the current QoS value marks sufficiently above a threshold QoS value, streaming is continued with the current server.

If it is determined in step 87 that the QoS value is lower than a threshold value, then sampling of alternate servers is initiated at step 89 in an attempt to locate a better performing server and connection. If no alternate servers having an estimated QoS value higher than the threshold are available, then a player may be adapted to accept a lower bit-rate at step 91. Changing to a lower bit rate allows a player to recover some quality by skipping frames and otherwise using less data to perform complete display of the multimedia content. Step 91 resolves back to step 87 wherein QoS is being determined and compared against the threshold value.

If in step 87 if it is determined that actual QoS value is falls below a threshold value then an alternate server is sought out at step 89. If a better performing server is found at step 89, a user is notified of options in step 95. If the decision made by a user is yes, then an appropriate command for switching is initiated and sent at step 97. At step 99 a user is re-directed to the new server. The process then resumes again at step 85.

If in step 95, a user rejects an option to switch, adaptation may be initiated to change to a lower bit-rate for player software. Step 101 is optional but practical in some cases.

It will be apparent to one with skill in the art the process steps represented herein may be added to or subtracted from without departing from the spirit and scope of the present invention. Step 95 is optional and may be eliminated from this example process. Step 89 may involve the sampling of many servers before any comparisons are made. In one embodiment, a first comparison may be that of all of the sample QoS values with the best estimated value being compared against the actual QoS value of a current server.

The method and apparatus of the present invention may be practiced on any DPN capable of supporting required protocols for multimedia data transfer. The present invention may be practiced from any network capable CPE having the appropriate computing power and software for receiving multimedia content, and suitable network connectivity for dynamic switching during playback of the media content. The present invention is likewise applicable to fixed and mobile wireless CPE systems.

The method and apparatus of the present invention may also be applied to data transfer systems engaged in data transfer other than streaming multimedia content without departing from the spirit and scope of the present invention. In this case, a user may be attempting a lengthy download of a software program available from a number of participating servers holding the same file. QoS statistics relative to the current downloading of a file from an initial server may be compared against sample estimates taken from the other participating servers. Dynamic switching in this case may be transparent to a user as described with multimedia streaming. Therefore, the method and apparatus of the present invention should be afforded the broadest scope possible under examination. The spirit and scope of the present invention is limited only by the claims that follow.

What is claimed is:

1. A system for replacing data services of a server-node connected to a client-node with data services available from an alternate server-node operating on a data-packet-network comprising;
a first server-node;
a client node coupled by data link to the first server-node;
an alternate second server-node connected to the network and accessible to the client node; and
a software module;
characterized in that the software module monitors one or more quality-of-service values from the first and second server nodes, and switches communication for the client node between server nodes accordingly.

2. The system of claim 1 wherein the switching is based on comparison of performance data collected and processed by the software module.

3. The system of claim 1 wherein the data services comprise streaming multimedia media content.

4. The system of claim 3 wherein the software module resides at the client location.

5. The system of claim 4 wherein the software module operates transparently to a user operating the client node.

6. A software module for enabling selective replacement of data services of a server-node connected to a client-node with data services available from an alternate server-node operating on a data-packet-network comprising;
a data input function for receiving data from external sources;
an analytical function for compiling received data and producing a result based on data comparison; and,
a command function for effecting a client-server connection switch.

7. The module of claim 6 wherein the termination of a current client-server connection and the establishment of a replacement client-server connection is based on comparison of performance data collected and processed by the module.

8. The module of claim 7 wherein the module resides at the client location.

9. The module of claim 8 wherein the module operates transparently to a user operating the client node.

10. The module of claim 9 wherein the processed performance data is compared against a pre-set threshold value.

11 The module of claim 10 wherein the collected performance data is equated to a point system and values are assigned to compiled sets of data.

12. The module of claim 11 wherein an option to switch client-server connection from one server node to an alternate server node is presented to a user operating at the client location.

13. A method for replacing data services of a server-node connected to a client-node with data services available from an alternate server-node operating on a data-packet-network comprising;
(a) monitoring performance characteristics of the server-node connected to the client node, and the performance characteristics of the network path between the server-node and the client-node;
(b) establishing a temporary client-server connection between the client-node and an alternate server-node;
(c) recording performance characteristics of the alternate server-node, and the performance characteristics of the network path between the alternate server-node and the client-node;
(d) comparing the total value of performance characteristics of the server-node with the estimated value of available performance characteristics of the alternate server-node; and
(e) initiating a client-to-server connection switch based on the results of the comparison.

14. The method of claim 13 wherein in step (a), monitored results are continuously compared against a pre-set threshold value for determination of whether to proceed to step (b).

15. The method of claim 13 wherein in step (e), initiation of the client-to server connection switch is user directed from the client location.
